(19) United States
(12) Patent Application Publication
(10) Pub. No.: US 2006/0096766 A1
(43) Pub. Date: May 11, 2006

(54) Farm tractor lift arm lock

(76) Inventor: Harley Warlick, Kodak, TN (US)

Correspondence Address: LITMAN LAW OFFICES, LTD, PO BOX 15035, CRYSTAL CITY STATION, ARLINGTON, VA, 22215, US

(21) Appl. No.: 11/095,460

(22) Filed: Apr. 1, 2005

Related U.S. Application Data
(60) Provisional application No. 60/558,997, filed on Apr. 5, 2004.

(51) Int. Cl. A01B 59/043

(52) U.S. Cl. 172/450

(57) ABSTRACT

The farm tractor lift arm lock is an anti-sway brace for a tractor that keeps the lift arms of a traditional three-point hitch from spreading excessively and keeps the angle between the arms constant. Two brackets attach to each of the lift arms and a rigid anti-sway bar extends laterally between the brackets, keeping the brackets, and thus the lift arms, from moving laterally relative each other. The farm tractor lift arm lock is made of metal and can either have the brackets welded to the ends of the anti-sway bar or can be of one-piece construction.

### CROSS-REFERENCE TO RELATED APPLICATION

This application claims the benefit of U.S. Provisional Patent Application Ser. No. 60/558,997, filed Apr. 5, 2004.

### BACKGROUND OF THE INVENTION

1. Field of the Invention

The present invention relates generally to mechanical mounting devices suitable for use with agricultural tractors, and more particularly to a lift arm lock for keeping the lift arms of a three-point hitch in a stable position, thereby reducing sway and reducing wear to the pivot points of the hitch.

2. Description of the Related Art

A three-point hitch is used on many agricultural tractors in order to drag farm implements, such as plows, rippers, rock rakes, and hay rakes, behind the tractor. A problem with the three-point hitch is that the lift arms (sometimes referred to as “links”) sway back and forth, making it difficult to control the implement being dragged by the tractor. The swaying of the links also puts an inordinate amount of stress on the pivot points, usually a floating ball, at each end of the links and wears out the floating balls so that they need to be frequently replaced.

Various solutions have been put forward on how to reduce the swaying of loads carried by tractors with three-point hitches, as well as hitches used by trucks and automobiles towing trailers. Most of these solutions involve external bars or mechanisms that provide additional support to the links and work to counteract the movement of the links. The related art does not reveal a device that simply locks the links in place and does not allow them to move.

U.S. Patent Publication No. 2002/0140205, published on Oct. 3, 2002, shows a sway control conversion bracket. The sway control conversion bracket is mounted on the side of the draw bar, rather than across the lift bars, as in the present invention. U.S. Pat. No. 2,698,564, issued Jan. 4, 1955 to Frederick D. Sawyer, teaches an implement hitch for trailers that has towing arms that are braced by angled anti-sway bars on the outside of the towing arms.

U.S. Pat. No. 2,727,756, issued Dec. 20, 1955 to Charley van Carlile, describes a tractor hitch adjuster that is designed to adjust and maintain the angularity of the towing arms, but is not designed to reduce sway. U.S. Pat. No. 2,775,180, issued Dec. 25, 1956 to W. H. Du Shane, shows a hitch device that includes a cushioning and brace member that has an internal spring to cushion the motion of the towing arms.

U.S. Pat. No. 3,306,628, issued Feb. 28, 1967 to Thomas P. Haxton, teaches a non-sway attachment for trailer hitches where a bar extends roughly parallel to the draw bars of a trailer. U.S. Pat. No. 3,520,556, issued Jul. 14, 1970 to Richard E. Warner, describes a load stabilizing trailer hitch that utilizes stabilizing arms on the outside of the towing arms. U.S. Pat. No. 3,583,484, issued Jun. 8, 1971 to Howard G. Thompson, describes a weight transfer hitch for plows that includes a hydraulic cylinder to transfer weight to the tractor so that traction on the rear wheels is increased.

U.S. Pat. No. 3,627,060, issued Dec. 14, 1971 to Norman F. Lemmon, discloses a draft link sway control mechanism which utilizes sway blocks rather than a lateral bar. U.S. Pat. No. 3,690,699, issued Sep. 12, 1972 to M. Arthur Derr, Jr., shows an anti-sway device for trailer hitches where the L-shaped bars used to reduce sway are mounted to the outside of the towing arms. U.S. Pat. No. 3,796,443, issued Mar. 12, 1974 to J. Warren Crutchfield, teaches a tractor rig and trailer hitch equipped with side-mounted anti-sway bars.

U.S. Pat. No. 3,910,355, issued Oct. 7, 1975 to Lee E. Elfes et al., describes a sway control device with guide rail members that do not fix the draft arms in a rigid position. U.S. Pat. No. 3,920,266, issued Nov. 18, 1975 to William L. Rendessy, discloses a dual-purpose trailer sway control device and safety connector for mounting on either the towed or towing vehicle which utilizes a belt on the outside of the towing connection.

Other patents showing anti-sway devices and lift arm locking devices include: U.S. Pat. No. 4,003,586, issued Jan. 18, 1977 to Jack R. Luck (sway resisting structure for trailers); U.S. Pat. No. 4,133,552, issued Jan. 9, 1979 to Gerald Sheine (control means for a vehicular tractor-trailer connection); U.S. Pat. No. 4,203,613, issued May 20, 1980 to Dieter Kunze (adjusting device for the draft link of a three-point mounting device); U.S. Pat. No. 4,236,724, issued Dec. 2, 1980 to Dieter Schillings (stabilizer for tractor hitch); U.S. Pat. No. 4,265,464, issued May 5, 1981 to Henry J. Lange (tractor draft link structure); U.S. Pat. No. 4,526,393, issued Jul. 2, 1985 to L. G. Smith (method for moving a grandstand and a hitch for connecting a tractor to an implement to be towed); U.S. Pat. No. 4,582,337, issued Apr. 15, 1986 to Paul Y. J. Hsueh (anti-sway trailer hitch); U.S. Pat. No. 4,919,215, issued Apr. 24, 1990 to Michael C. Lee et al. (hitch with anti-sway link); U.S. Pat. No. 5,628,525, issued May 13, 1997 to John J. Kass et al. (anti-sway friction pads for trailer hitch); and U.S. Pat. No. 5,868,414, issued Feb. 9, 1999 to Richard McCoy et al. (weight distributing and sway controlling hitch assembly).

Other devices related to tractor hitches are shown in United Kingdom Patent No. 614,653, published Dec. 20, 1948 (improvements in and relating to agricultural tractors); and European Patent No. 1,116,431, published Jul. 18, 2001 (tractor hitch with sway bumper).

None of the above inventions and patents, taken either singly or in combination, is seen to describe the instant invention as claimed. Thus, a farm tractor lift arm lock solving the aforementioned problems is desired.

### SUMMARY OF THE INVENTION

The farm tractor lift arm lock of the present invention is an anti-sway brace for a tractor that keeps the lift arms of a traditional three-point hitch from spreading excessively and keeps the angle between the arms constant. The lift arm lock has two brackets that fit over each of the lift arms and are attached to an anti-sway bar that extends laterally between the brackets to keep the brackets, and thus the towing arms, from moving relative each other. The farm tractor lift arm lock is made of metal and can either have the brackets welded to the ends of the anti-sway bar or can be of one-piece construction.

Each of the brackets on the farm tractor lift arm lock has two metal plates separated by a spacer at the top of the metal plates. The top of the bracket is therefore closed. The space between the metal plates is the width of the lift arms so that the bracket snugly fits over the lift arms. Alternatively, the brackets may comprise a single metal plate that fits into slots welded or otherwise attached to the lift arms.

The anti-sway bar is a straight piece of metal pipe or bar stock. If the power takeoff for an individual tractor would interfere with the farm tractor lift arm lock then the anti-sway bar may be curved in order to avoid the power takeoff. The anti-sway bar may also be in two segments that are bolted together and capable of being pivoted in order to accommodate lift arms that are at an angle.

It is an aspect of the invention to provide improved elements and arrangements thereof for the purposes described which is inexpensive, dependable and fully effective in accomplishing its intended purposes.

These and other features of the present invention will become readily apparent upon further review of the following specification and drawings.

### BRIEF DESCRIPTION OF THE DRAWINGS

FIG. 1 is a diagrammatic, environmental, perspective view of a farm tractor lift arm lock according to the present invention as used on a three-point hitch.

FIG. 2 is a perspective view of a farm tractor lift lock according to the present invention featuring brackets designed to fit over the lift arms of a three-point hitch.

FIG. 3 is a front view of a farm tractor lift lock according to the present invention.

FIG. 4 is a top view of a farm tractor lift lock according to the present invention.

FIG. 5 is a perspective view of an alternative embodiment of a farm tractor lift lock according to the present invention having a curved anti-sway bar.

FIG. 6 is an exploded, fragmented, perspective view of a farm tractor lift lock according to the present invention having adjustable brackets.

FIG. 7 is a perspective view of an alternative embodiment of a farm tractor lift lock according to the present invention having an adjustable anti-sway bar.

FIG. 8 is an exploded, perspective view of the farm tractor lift lock of FIG. 7.

FIG. 9 is a perspective view of a lift arm according to the present invention having slot for receiving a farm tractor lift arm lock of the present invention.

Similar reference characters denote corresponding features consistently throughout the attached drawings.

### DETAILED DESCRIPTION OF THE PREFERRED EMBODIMENTS

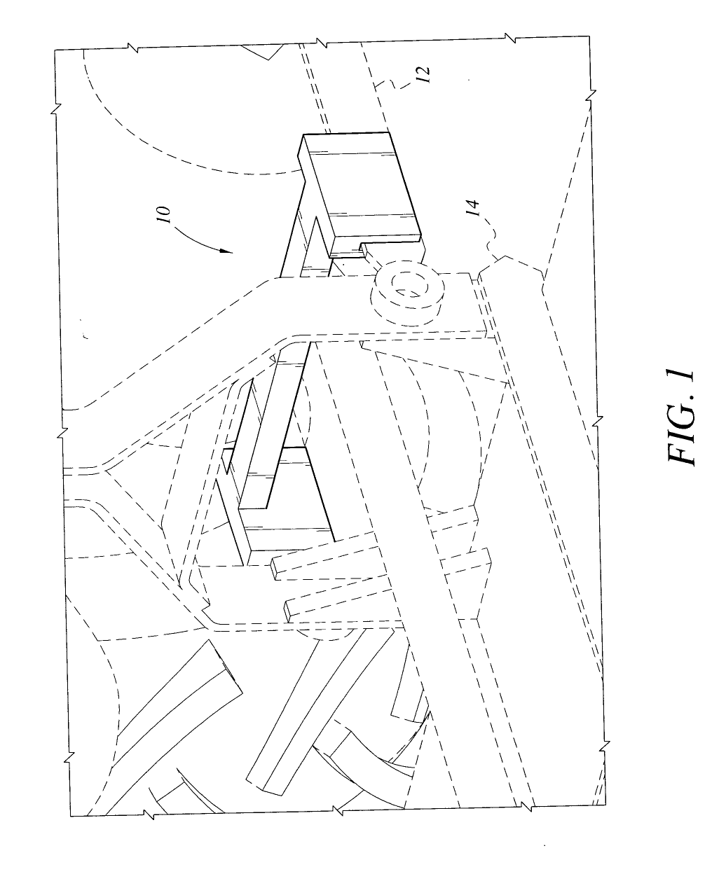

The present invention is a farm tractor lift arm lock, designated generally as 10 in the drawings. FIG. 1 shows the farm tractor lift arm lock 10 in place over the lift arms 12 of a tractor with a three-point hitch pulling a rock rake 14.

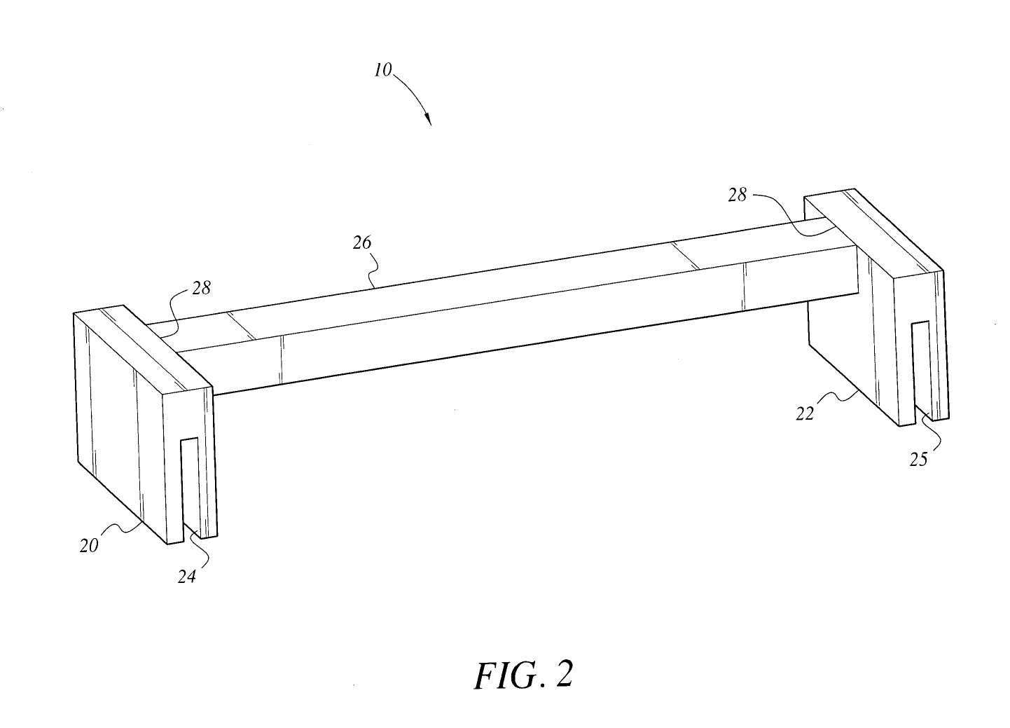

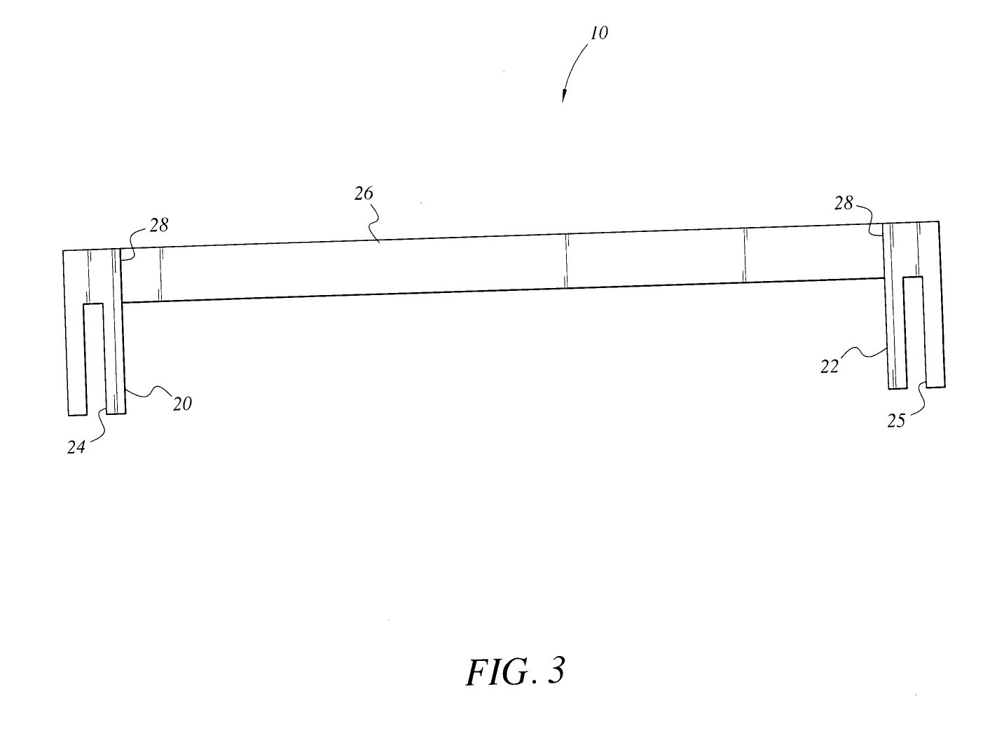

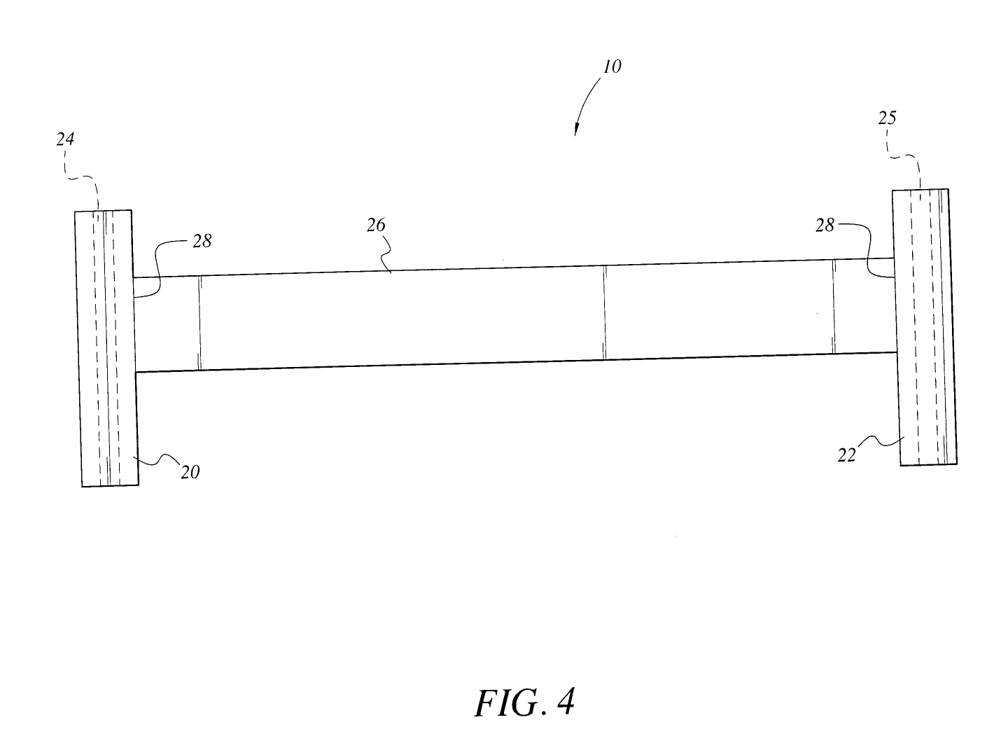

FIGS. 2-4 show the farm tractor lift arm lock 10 in its most simple form. Brackets 20 and 22 are attached at each end 28 of the anti-sway bar 26. Brackets 20 and 22 are have respective downward opening slots 24 and 25 defined in their respective bottom ends which enable the lift arm lock 10 to be placed over the lift arms of a three-point hitch and lock the arms 12 into place by a friction fit. By locking the arms in place, the load connected to the three-point hitch is prevented from swaying laterally and wear to the pivot points of the three-point hitch is greatly reduced. As shown, the anti-sway bar 26 is an elongate element of rigid metal bar stock, which may be solid or tubular. The anti-sway bar 26 may take the shape of pipe or angle iron or any other type of metal stock capable of supporting brackets 20 and 22 at either end and with enough rigidity to accomplish the objective of keeping the lift arms 12 of a three point hitch stable. It will be understood that brackets 20 and 22 may be welded to the ends of bar 26, or the assembly may be cast or forged in a single piece. The slots 24 and 25 are of such dimensions as to snugly fit over lift arms 12 to avoid relative swaying.

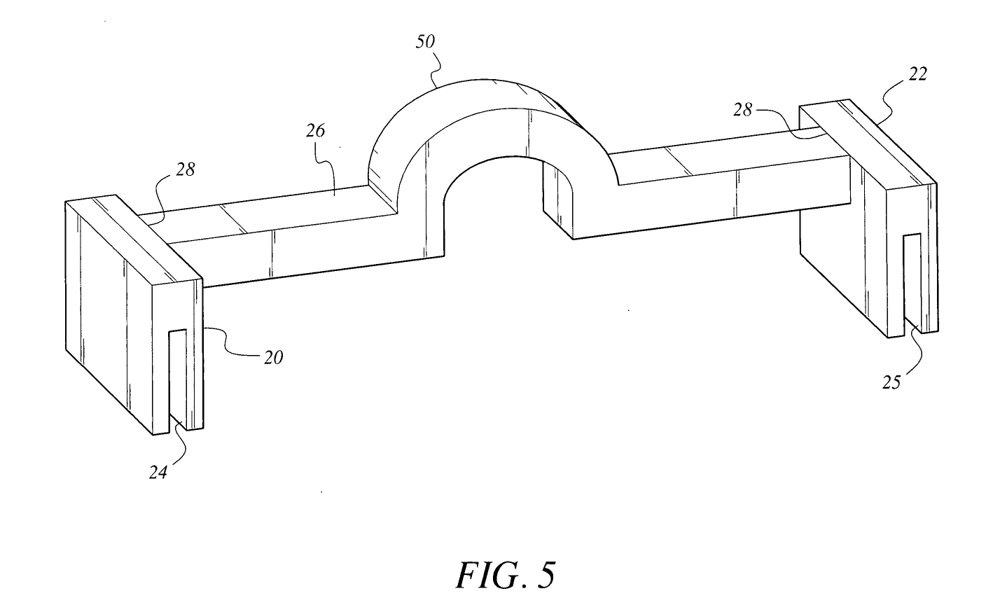

It sometimes may be necessary to have an arch 50 centrally located in the anti-sway bar 26, as shown in the embodiment of FIG. 5, to avoid the power takeoff of the tractor.

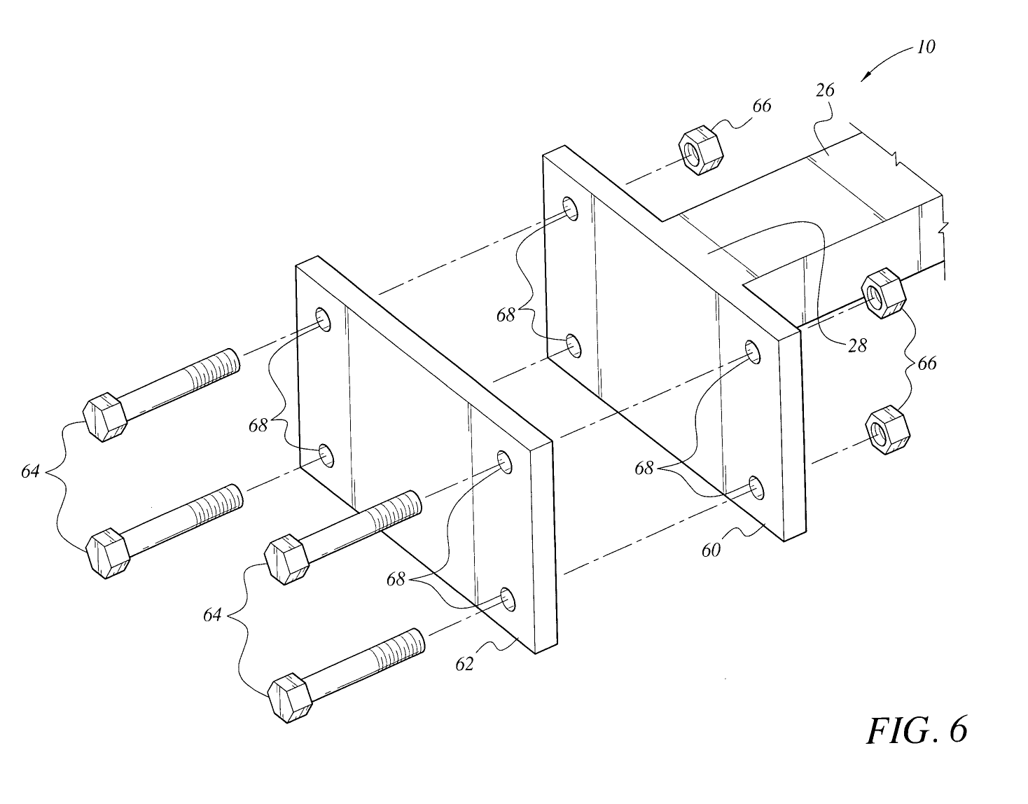

An alternative embodiment of the lift arm lock 10 (partially cut away) is shown in FIG. 6. The brackets, as exemplified in FIG. 6, have an inner plate 60 attached to each end 28 of the anti-sway bar 26. An outer plate 62 is then bolted to the inner plate 60 with the lift arm clamped between inner plate 60 and outer plate 62 using bolts 64 inserted through bolt holes 68 and secured by nuts 66. This arrangement allows the farm tractor lift arm lock 10 to be retrofitted for use with various types of three-point hitches that may have lift arms 12 of different dimensions.

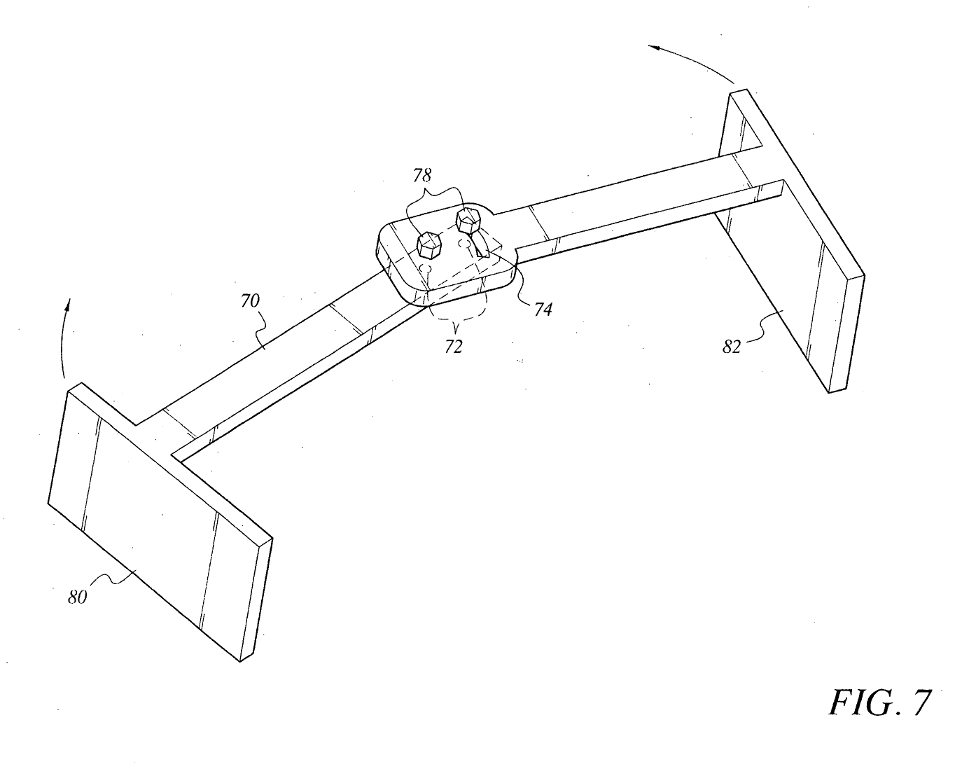

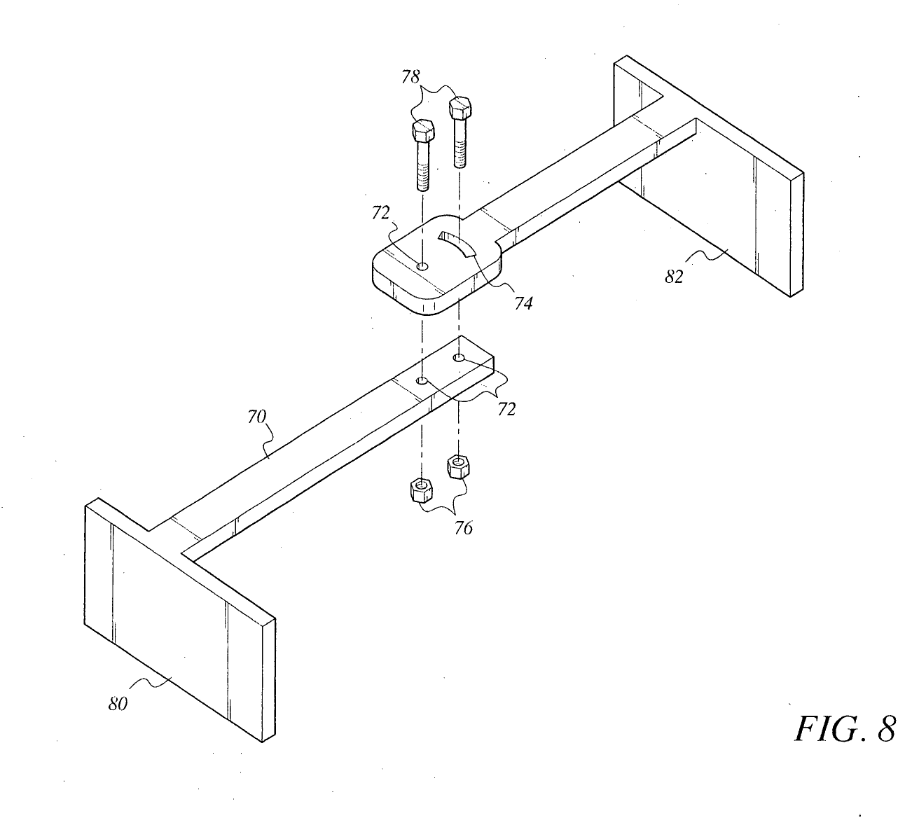

Another embodiment 70 of the present invention has an adjustable, hinged, anti-sway bar made up of an adjustment bar member 84 and a hinge bracket bar member 86, as shown in FIGS. 7 and 8. If the lift arms 12 of a three-point hitch 14 are at an angle, the farm tractor lift arm lock 10 can be attached by adjusting the angle of the two members 84 and 86. The outward ends 85 and 87 of each of the two members 84 and 86 are attached to the alternative brackets 80 and 82. The inward end of adjustment bar 84 defines spaced hinge and adjustment bolt bores 72. The inward end of hinge bracket bar 86 forms a hinge bracket 76 having a hinge bolt bore 72 and defining an arcuate, slot 74 spaced outward therefrom. A first of bolts 78 extends through the hinge bolt bores 72 and a second of bolts 78 extends through the adjustment bolt bore 72 and arcuate slot 74. The hinge bracket 76 is rotated to the desired angle and nuts 76 secure the adjustment bar 84 to the hinge bracket bar 86 to secure the two pieces of the adjustable anti-sway bar of adjustable lift arm lock 70 together at a desired angle as required to fit over and secure the lift arms 12.

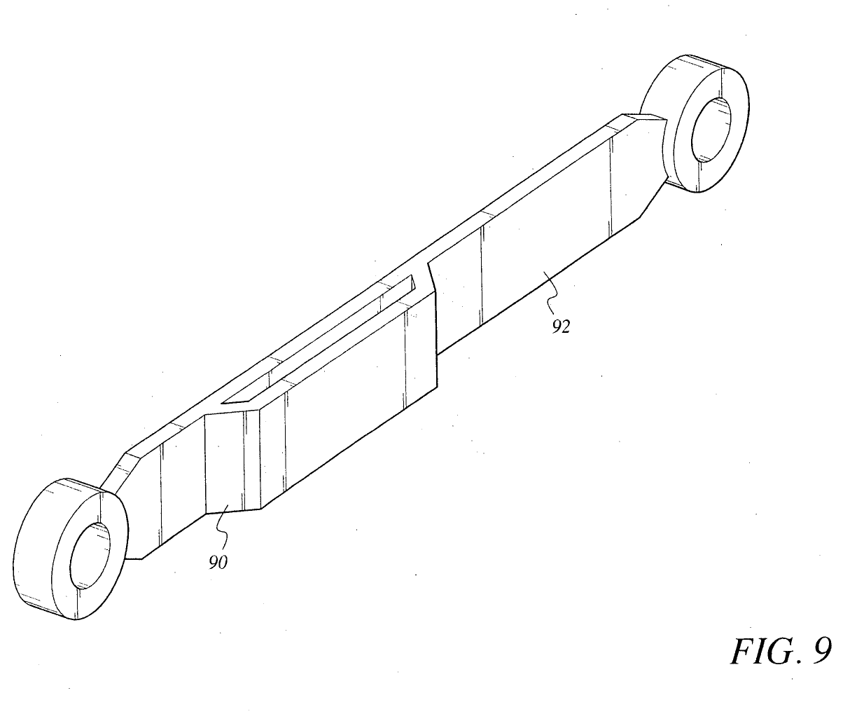

FIGS. 7 and 8 also show alternative brackets 80 and 82. Alternative plate brackets 80 and 82 are single metal plates attached to the respective ends 85 and 87 of the adjustable anti-sway bar and are dimensioned to fit into a slot 90 formed by a slot structure 94 attached to each lift arm 92, or to a lift arm 92 furnished with slot 90 during original manufacture for this purpose, as exemplified in FIG. 9. Plate brackets 80 and 82 fit snugly into slots 90 to maintain the lift arms 92 in their desired relative position.

It is to be understood that the present invention is not limited to the embodiments described above, but encompasses any and all embodiments within the scope of the following claims.

I claim:

1. A farm tractor lift arm lock, comprising:
a pair of brackets adapted for attachment to opposing lift arms of a tractor supporting a three-point hitch; and
an elongate, rigid anti-sway bar extending between said brackets;
whereby upon attachment of said brackets to respective lift arms the lift arms are prevented from swaying laterally and angularly relative to each other.

2. The farm tractor lift arm lock according to claim 1, wherein said anti-sway bar has a centrally located upward arch formed therein.

3. The farm tractor lift arm lock according to claim 1, wherein said anti-sway bar is adjustable, formed by an elongate adjustment bar and an elongate hinge bracket bar of about equal length, said adjustment bar having an outer end and an inner end portion defining a hinge bolt bore and an adjustment bolt bore spaced inward therealong, said hinge bracket bar having an outer end and an inner end portion forming an inner hinge bracket defining an inner vertical bolt hinge bore and a spaced arcuate slot therein, said adjustable anti-sway bar having a hinge bolt extending through said hinge bores and having a tightening nut and an adjustment bolt extending through said arcuate slot and adjustment bore and having a tightening nut, whereby said anti-sway bar is formed from said adjustment bar and said hinge bracket bar in a straight line or at a desired angle by rotating said bars relative to each other around said hinge bolt and tightening said hinge bolt nut and said adjustment bolt is tightened over said arcuate slot and said adjustment bore by said adjustment bore nut.

4. The farm tractor lift arm lock according to claim 1, wherein each of said lift-arms has a slot forming structure attached thereto and each said brackets is a single, downward directed metal plate adapted for insertion into a slot defined in the lift arm.

5. The farm tractor lift arm lock according to claim 1, wherein each of said brackets includes an inner plate attached to a respective end of said anti-sway bar and a corresponding outer plate, said corresponding inner plates and outer plates defining a plurality of aligned bolt bores around their peripheries, and a plurality of bracket bolts and nuts extending through respective said aligned bolt bores whereby, upon placing respective lift arms between respective said inner plates and outer plates and tightening said nuts on said bolts against said plates, said lift arm lock engages said lift arms.

6. A farm tractor lift arm lock, comprising:
a pair of brackets adapted for attachment to opposing lift arms of a tractor supporting a three-point hitch; and
an elongate, rigid anti-sway bar extending between said brackets;
whereby upon attachment of said brackets to respective lift arms the lift arms are prevented from swaying laterally and angularly relative to each other.

7. The farm tractor lift arm lock according to claim 6, wherein said anti-sway bar is adjustable, formed by an elongate adjustment bar and an elongate hinge bracket bar of about equal length, said adjustment bar having an outer end and an inner end portion defining a hinge bolt bore and an adjustment bolt bore spaced inward therealong, said hinge bracket bar having an outer end and an inner end portion forming an inner hinge bracket defining an inner vertical bolt hinge bore and a spaced arcuate slot therein, said adjustable anti-sway bar having a hinge bolt extending through said hinge bores and having a tightening nut and an adjustment bolt extending through said arcuate slot and adjustment bore and having a tightening nut, whereby said anti-sway bar is formed from said adjustment bar and said hinge bracket bar in a straight line or at a desired angle by rotating said bars relative to each other around said hinge bolt and tightening said hinge bolt nut and said adjustment bolt is tightened over said arcuate slot and said adjustment bore by said adjustment bore nut.

8. A farm tractor lift arm lock, comprising:
a pair of brackets adapted for attachment to opposing lift arms of a tractor supporting a three-point hitch; and
an elongate, rigid anti-sway bar extending between said brackets;
whereby upon attachment of said brackets to respective lift arms the lift arms are prevented from swaying laterally and angularly relative to each other.

9. The farm tractor lift arm lock according to claim 8, wherein each of said lift arms has a slot forming structure attached thereto and each said brackets is a single, downward directed metal plate adapted for insertion into a slot defined in the lift arm.

10. The farm tractor lift arm lock according to claim 9, wherein each of said brackets includes said inner plate attached to a respective end of said anti-sway bar and a corresponding outer plate, said corresponding inner plates and outer plates defining a plurality of aligned bolt bores around their peripheries, and a plurality of bracket bolts and nuts extending through respective said aligned bolt bores whereby, upon placing respective lift arms between respective said inner plates and outer plates and tightening said nuts on said bolts against said plates, said lift arm lock engages said lift arms.
